(19) United States
(12) Patent Application Publication
(10) Pub. No.: US 2011/0013271 A1
(43) Pub. Date: Jan. 20, 2011

(54) SOLAR ENERGY REFLECTION PLATE FOR SUPPRESSING GLOBAL WARMING

(75) Inventor: Kenji Kawai, Tokyo (JP)

Correspondence Address: BOYLE FREDRICKSON S.C., 840 North Plankinton Avenue, MILWAUKEE, WI, 53203, US

(73) Assignee: Tuner Holdings Kabushiki Kaisha, Nishitokyo Tokyo (JP)

(21) Appl. No.: 12/918,356

(22) PCT Filed: Feb. 10, 2009
(86) PCT No.: PCT/JP2009/052205

§ 371 Date: Oct. 1, 2010

(30) Foreign Application Priority Data
Feb. 19, 2008 (JP) 2008-036941

(51) Int. Cl. G02B 7/198

(52) U.S. Cl. 359/350; 359/872; 359/850

(57) ABSTRACT

A solar energy reflection plate for suppressing global warming of the present invention has a reflection plate so installed on a ground surface that the reflection surface thereof is positioned horizontally to the ground surface. Further, the solar energy reflection plate for suppressing global warming of the present invention has a reflection plate, and a base for fixing the reflection plate so as to tilt the reflection surface thereof at a desired angle in relative to the ground surface. Further, the desired angle is such an angle that when a sun altitude in a region where the reflection plate is installed becomes maximum, sunlight is reflected in a direction perpendicular to the ground surface of the region.

### BACKGROUND OF THE INVENTION

1. Field of the Invention

This invention relates to a solar energy reflection plate for suppressing global warming and more particularly relates to a solar energy reflection plate for suppressing global warming, wherein solar energy entering into the atmosphere of the earth can be radiated effectively away from the earth.

2. Description of the Related Art

As shown in FIG. 10, main energy entered into and absorbed by the atmosphere 2 of the earth 1 per unit time comprises a solar energy 3 such as an electromagnetic wave energy etc. ejected from the sun and absorbed by the atmosphere 2 and the earth 1, a geothermal energy 4, and an energy 5 consumed by humans and converted mainly into heat. There is an electromagnetic wave energy etc. 6 ejected naturally from the earth 1 and the atmosphere 2 to the outer space. It is considered that the sum of the solar energy 3, the geothermal energy 4, and the energy 5 consumed by humans and converted mainly into heat is the same substantially with the electromagnetic wave energy etc. 6 ejected naturally to the outside of the atmosphere 2 of the earth 1, because the average temperature on the earth is not varied to a large extent from year to year.

However, recently there is a tendency of the global warming, because the solar energy 3 such as electromagnetic wave energy etc. ejected from the sun and absorbed by the atmosphere 2 and the earth 1, or the energy 5 consumed by humans and converted mainly into heat is increased, or the electromagnetic wave energy etc. 6 ejected naturally to the outside of the atmosphere 2 of the earth 1 is reduced by the increase of green house effect gas such as CO₂ etc. ejected from humans.

Accordingly, in order to suppress global warming, in the present invention, the quantity of solar energy absorbed by the atmosphere of the earth or on the earth is reduced, or solar energy is reflected from a region of high temperature to a region of low temperature, and the solar energy is transmitted at a high speed as a radiation of light different from the transmission or circulation of heat, so that the consumption of energy for use in the cooler or heater in each region is reduced to suppress global warming.

### SUMMARY OF THE INVENTION

A solar energy reflection plate for suppressing global warming of the present invention is characterized by comprising a reflection plate so installed on a ground surface that the reflection surface thereof is positioned horizontally to the ground surface.

Further, a solar energy reflection plate for suppressing global warming of the present invention is characterized by comprising a reflection plate, and a base for fixing the reflection plate so as to tilt the reflection surface thereof at a desired angle in relative to a ground surface.

Further, the desired angle is characterized by such an angle that when a sun altitude in a region where the reflection plate is installed becomes maximum, sunlight is reflected in a direction perpendicular to the ground surface of the region.

Further, the desired angle is characterized by 0°.

Further, the desired angle is characterized by such an angle that sunlight is reflected in a direction passing through an atmosphere on a region higher in latitude than the region where the reflection plate is installed.

Further, when a sun altitude in a region where the reflection plate is installed becomes maximum, the desired angle for reflecting sunlight in a direction perpendicular to the ground surface of the region is characterized by (A−B)/2, where A is a latitude of the region, and B is a latitude of the regression line, in case that the region is higher in latitude than the north or south regression line.

Further, when a sun altitude in a region where the reflection plate is installed becomes maximum, the desired angle for reflecting sunlight in a direction perpendicular to the ground surface of the region is characterized by 0°, in case that the region is lower in latitude than the north or south regression line.

Further, it is characterized in that a plurality of reflection plates are so arranged that reflection surfaces of the reflection plates form a convex surface or a planar surface.

Further, it is characterized in that the reflection plate is a plane mirror.

Further, it is characterized in that the reflection plate has a high reflection rate with respect to ultra violet rays, visible rays, and infrared rays in regions of wavelengths of 0.2-1.2 μm, 1.6-1.8 μm, 2-2.5 μm, 3.4-4.2 μm, 4.4-5.5 μm, 8-14 μm, which are so called as “atmospheric window”.

According to the solar energy reflection plate for suppressing global warming of the present invention, the global warming can be suppressed by reflecting solar energy and ejecting excess energy into the outside of the atmosphere of the earth 1 by using a mirror simple in structure and low in cost.

Further, the increase of the temperature in summer can be suppressed, the quantity of electrical power for use in the cooler can be reduced in summer, and thus the global warming can be suppressed.

Further, a reflection surface of the reflection plate is so inclined with respect to the ground surface as to reflect the sun light normally to the ground surface of the region where the refection plate is arranged when the sun latitude at the region becomes maximum, so that the path of the reflected light in the atmosphere of the earth can be shortened, that the quantity of the reflected light absorbed by the atmosphere of the earth can be minimized, and that the solar energy can be ejected to the outside of the earth more effectively. Further, in case that the minor is inclined as above, the path of the reflected light in the atmosphere can be more shortened than in a case that the inclined angle is 0°, even in the season that the sun altitude is not maximum, so that the absorbing quantity of the reflected light in the atmosphere can be reduced.

Further, the reflection surface of the reflecting plate is so inclined with respect to the ground surface as to reflect the sun light passing through an atmosphere on a region higher in latitude than a region on which the reflecting plate is positioned. Accordingly, the solar energy is transmitted at a high speed as a radiation of light different from the transmission or circulation of heat, so that the elevation of the temperature at a region of high latitude and low temperature or the consumption of energy for sue in the heater in this region is reduced, and that the global warming can be suppressed. Further, the distribution of heat energy on the earth can be uniformed and accordingly the power of the typhoon etc. generated by the temperature difference at the regions different in latitude from one another can be reduced.

Further, the distribution of heat energy on the earth can be uniformed and the power of the typhoon etc. generated by the temperature difference at the regions different in latitude form one another can be reduced, by arranging the reflection plates of the present invention at regions centering around a region of high temperature.

### BRIEF DESCRIPTION OF THE DRAWINGS

FIG. 1 is a side view of a first embodiment of a solar energy reflection plate for suppressing global warming of the present invention.

FIG. 2 is a view for expelling the first embodiment of a solar energy reflection plate for suppressing global warming of the present invention.

FIG. 3 is a view showing the relation between wavelength and radiant quantities of an electromagnetic wave ejected from the sun and ejected from the earth naturally.

FIG. 4 is a view showing a relation between wavelength of an electromagnetic wave and permeability of the electromagnetic wave in the atmosphere.

FIG. 5 is a side view of a second embodiment of a solar energy reflection plate for suppressing global warming of the present invention.

FIG. 6 is a view for explaining the second embodiment of a solar energy reflection plate for suppressing global warming of the present invention.

FIG. 7 is a view for explaining the second embodiment of a solar energy reflection plate for suppressing global warming of the present invention.

FIG. 8 is a view for explaining the second embodiment of a solar energy reflection plate for suppressing global warming of the present invention.

FIG. 9 is a view for explaining the second embodiment of a solar energy reflection plate for suppressing global warming of the present invention.

FIG. 10 is a view for explaining energy entered into atmosphere of the earth, absorbed by the atmosphere, and ejected from the atmosphere per unit time.

### REFERENCE CHARACTERS

1 earth
2 atmosphere
3 solar energy
4 geothermal energy
5 energy
6 energy etc.
7 plane mirror
8 ground surface
9 line
10 line
11 base
12 equator
13 autorotation axis

### DETAILED DESCRIPTION OF THE PREFERRED EMBODIMENTS

Embodiments of the present invention will now be explained with reference to the drawings.

### Embodiment 1

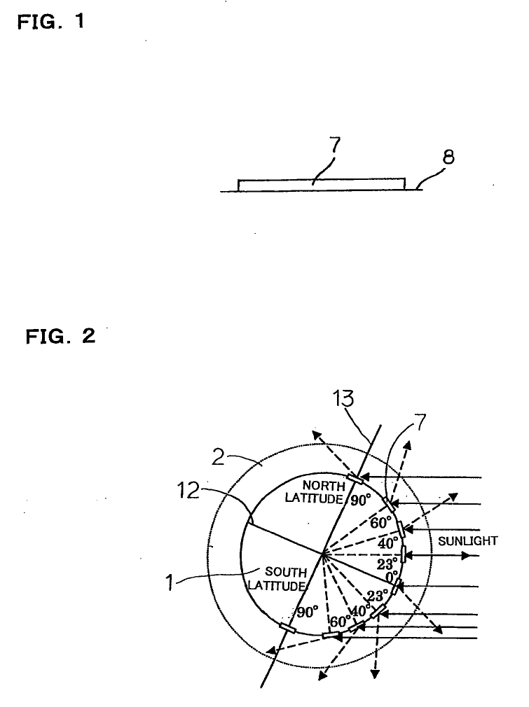

A solar energy reflection plate for suppressing global warming according to the present invention, as shown in FIG. 1, comprises a rectangular plane mirror 7 of 1 m×1 m relatively simple in structure and low in cost for reflecting sunlight regularly, but not irregularly. The plane mirror is not a concave or convex mirror. The plane mirror 7 is so arranged on a ground surface 8 or a roof of house (it is called as a ground surface, hereinafter) that the minor surface thereof is positioned horizontally to the ground surface 8.

FIG. 2 shows incidence angles and reflection angles of the sunlight with respect to the mirrors installed on positions different in latitude from one another at 0 p.m. of the summer solstice of North hemisphere and the winter solstice of South hemisphere. In FIG. 2, a reference numeral 12 denotes the equator and a reference numeral 13 denotes an autorotation axis.

In case that the minor is so installed that 0.05% of the solar energy received by the ground surface of the earth (sectional area of the earth is π r², where r is a semidiameter of the earth) is reflected (the rate can be calculated to about 0.1% of the surface area of the earth, under the consideration that the surface area of the earth is 2 π r², which is twice of the sectional area of the earth, though it depends on the inclined angle of the mirror and the latitude of the position where the mirror is installed. It is considered that 0.0106% of the solar energy reached to the earth from the sun can be reflected to the outer space, if it is assumed that the reflection rate of the general grass mirror with respect to the visible lay, which is about one half of the lay reached to the ground surface from the sun is 70%, that 55% of the energy of 1.7×10¹⁷ W is reached to the earth from the sun, and that 55% of the energy which is similar to that received by the earth is ejected to the outside of the atmosphere 2, and that the energy reflected by the reflection mirror of the present invention to the outer space is 0.55×0.0005×0.7×0.55=0.000106. In case that no mirror is installed, reflected energy by the ground surface of the earth to the outside of the atmosphere becomes 0.000605% of the energy reached to the earth from the sun, because the reflection rate of the ground surface of the earth is 4%. This means that the reflection rate can be increased by 0.010% according to the mirror of the present invention. The energy 5 consumed by humans and converted mainly into heat is about 0.0001% of the solar energy 3 (which is 0.007% of the energy reached to the earth from the sun) and accordingly the quantity of energy consumption can be reduced remarkably by the present invention. If it is assumed that the earth is spherical, the surface area thereof is 4 π r²=450,000,000 km², and 0.1% thereof is 450,000 km². A proposed site for setting the plane mirror 7 is a desert. The area of the Sahara Desert is the largest in the world and is about 10,000,000 km², which is 2.2% of the surface area of the earth and 22 times of the 0.1% area. The number of population in the world is considered as about 6×10⁹ and accordingly, the above energy reflection rate can be realized if each of the mirrors is installed in the area of 75 m² (about 8.7 m×8.7 m) by each person. A further effect can be expected if the rate of area per mirror and the reflection rate of the mirror are increased.

The incidence angle and the reflection angle of the sunlight with respect to the ground surface are the same with each other. Accordingly, it is preferable to reflect the sunlight by a mirror installed in a region high in latitude and not faced to the sun to a region of higher in latitude and low in temperature. Further, the energy of the sunlight is transmitted to the region at a high speed as a radiation of light different from the transmission or circulation of heat, so that the elevation in temperature of the region where the mirror is installed can be suppressed and accordingly the consumption of energy for use in the heater at this region can be reduced, and that the global warming can be suppressed. Further, the distribution of the heat energy on the earth can be equalized, and accordingly the power such as the typhoon etc. generated by the temperature difference of the different latitude regions can be reduced.

Further, it is preferable to install the mirrors on regions centering around a region low in latitude, and thus the incidence angle of sunlight is large, and high in temperature, so that the temperature of the rejoins where the mirrors are installed can be lowered, that the temperature difference between the near place of the equator and the near place of the north pole or the south pole is reduced, and that it is expected to reduce the power of the typhoon etc.

Further, it is preferable that the mirror installed in the region relatively high in latitude is covered with a cover of high extinction rate of the solar energy in the winter season in order to prevent the temperature from being lowered extremely.

Further, it is preferable to install the mirror at the housetop, roof, high ground or vast desert in order to prevent a bad influence due to the sunlight reflected from the mirror from being exerted on the car etc. running on the road.

If the mirror surface is not flat, but a concave or convex, the bundle of reflection lights is focused and caused a fire etc. Accordingly, it is necessary to use a mirror having a sufficient flatness and solidity in order to prevent the mirror from being deflected by the weight of the mirror.

In case that a plurality of mirrors are used. If the mirrors are so arranged that reflection surfaces of the reflection plates form a concave surface, the bundle of the reflection lights forms a focal point and causes a fire etc. Accordingly, it is necessary to arrange the plural mirrors so as to form by the reflection surfaces thereof a convex surface or a planar surface. Further, it is accepted that any clearance or step is formed between the mirrors so far as the lights reflected from the reflection surfaces formed by the plural mirrors are not focused.

Further, it is preferable to use a reflection plate of high reflection rate in each region of wavelength of the infrared rays occupied about one half of the energy reached to the ground surface from the sun and to suppress the reflection of visible light in order to prevent a bad influence from being exerted on the airplane etc. flying in the air.

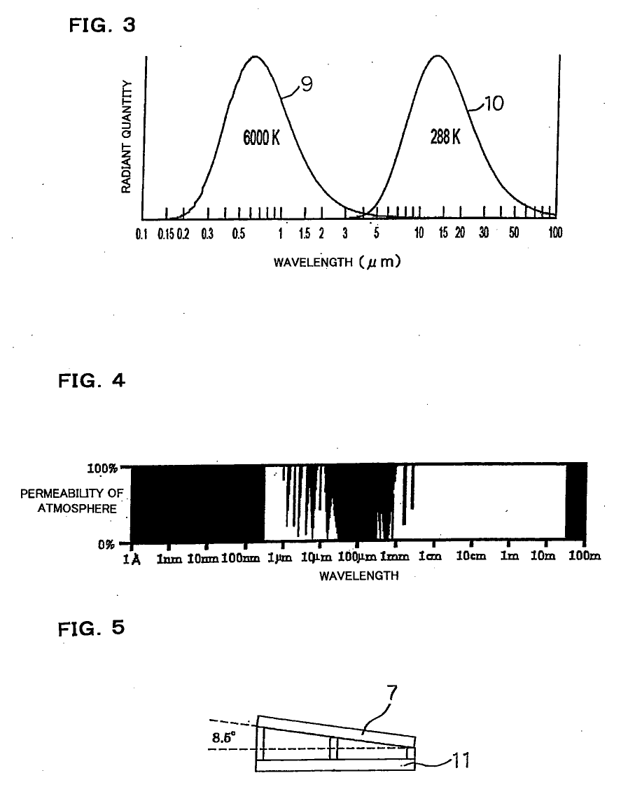

FIG. 3 shows a graph showing a relation between the wavelength and radiant quantity of the solar energy entered to the earth and ejected from the earth naturally. A line 9 shows a spectrum distribution of normalized black body radiation corresponding to 6000K which is near the temperature of the solar energy, and a line 10 shows a spectrum distribution of normalized black body radiation corresponding to 288K which is near the temperature of the energy ejected naturally. In the former radiation, the visible ray near 0.5 □m is most strong and in the latter the infrared ray near 8-12 □m is most strong. Further, FIG. 4 shows a relation between wavelength of an electromagnetic wave and permeability of the electromagnetic wave in the atmosphere. Regions of wavelengths of 0.2-1.2 □m, 1.6-1.8 □m, 2-2.5 □m, 3.4-4.2 □m, 4.4-5.5 □m and 8-14 □m, etc. are so called as “atmospheric window” wherein the permeability of electromagnetic wave in the atmosphere is high. It is preferable to use a reflection plate of high reflection rate with respect to ultra violet rays, visible rays and infrared rays in regions of wavelengths of 0.2-1.2 □m, 1.6-1.8 □m, 2-2.5 □m, 3.4-4.2 □m, 4.4-5.5 □m and 8-14 □m. Especially, it is preferable to use a reflection plate of high reflection rate with respect to infrared rays in regions of wavelengths of 0.83-1.2 □m etc. which occupies a relatively large portion of the solar energy, as shown by the line 9 in FIG. 3 and FIG. 4.

Further, it is considered that it is effective to determine by the law etc. the installation of the mirrors in order to increase the reflection rate of the solar energy.

### Embodiment 2

A solar energy reflection plate for suppressing global warming according to a second embodiment of the present invention, as shown in FIG. 5, comprises a rectangular plane mirror 7 of 1 m×1 m and a base 11 for fixing the mirror 7. The reflection plate of the present invention is relatively simple in structure and low in cost. The plane mirror 7 is not a concave or convex mirror and reflect sunlight regularly, but not irregularly. The plane mirror 7 is so arranged that the mirror surface thereof is tilted at a desired angle in relative to a region where the mirror 7 is installed.

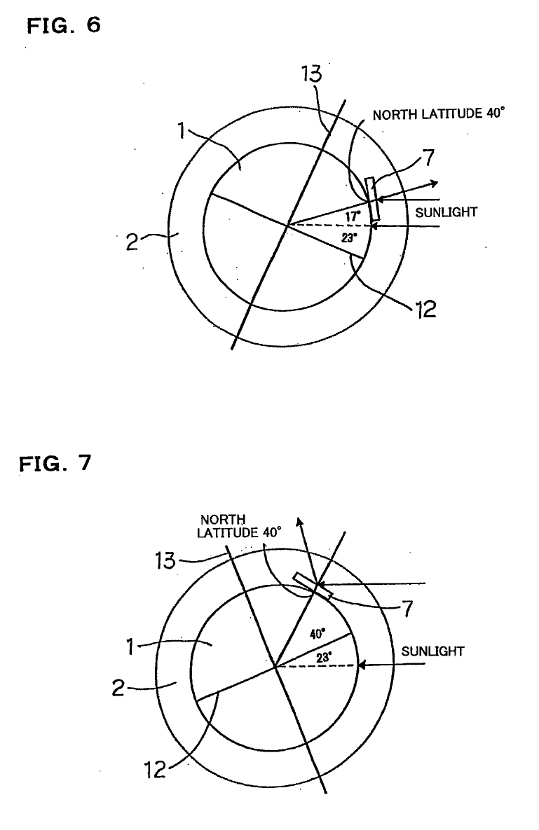

The desired angle is so determined that the sunlight is reflected normally with respect to the ground surface when a sun altitude on the region becomes maximum at that angle. The desired angle for reflecting the sunlight normally with respect to the ground surface when the sun altitude at the region where the plane mirror 7 is installed becomes maximum is expressed concretely by (A−B)/2, where A is a latitude of a region where the reflection plate is installed, and B is a latitude of the regression line, and expressed by 0° at a region lower in latitude than north regression line or south regression line. For example, in case that the plane mirror 7 is installed at a region of north latitude 40° which is higher in latitude than the north regression line (23°), the sun altitude becomes maximum at 0 p.m. of the summer solstice and the inclined angle of the mirror surface to the ground surface becomes (40°−23°)/2=8.5°, as shown in FIG. 6.

In the solar energy reflection plate for suppressing global warning according to the second embodiment of the present invention, as like as the first embodiment, if the mirror is so installed that 0.05% of the solar energy received by the ground surface of the earth (sectional area of the earth is π r², where r is a semidiameter of the earth) is reflected (the rate can be calculated to about 0.1% of the surface area of the earth under the consideration that the surface area of the earth is 2 π r², which is twice of the sectional area of the earth, though it depends on the inclined angle of the mirror and the latitude of the position where the mirror is installed. It is considered that 0.0106% of the solar energy reached to the earth from the sun can be reflected to the outer space, if it is assumed that the reflection rate of the general grass mirror with respect to the visible lay, which is about one half of the lay reached to the ground surface from the sun is 70%, that 55% of the energy of 1.7×10¹⁷ W is reached to the earth from the sun, and that 55% of the energy which is similar to that received by the earth is ejected to the outside of the atmosphere 2, and that the energy reflected by the reflection mirror of the present invention to the outer space is 0.55×0.0005×0.7×0.55=0.000106. In case that no mirror is installed, reflected energy by the ground surface of the earth to the outside of the atmosphere becomes 0.000605% of the energy reached to the earth from the sun, because the reflection rate of the ground surface of the earth is 4%. This means that the reflection rate can be increased by 0.010% according to the mirror of the present invention. The energy 5 consumed by humans and converted mainly into heat is about 0.0001% of the solar energy 3 (which is 0.007% of the energy reached to the earth from the sun) and accordingly the quantity of energy consumption can be reduced remarkably by the present invention. If it is assumed that the earth is spherical, the surface area thereof 4 π r²=450,000,000 km², and 0.1% thereof is 450,000 km². A proposed site for setting the plane mirror 7 is a desert. The area of the Sahara Desert is the largest in the world and is about 10,000,000 km², which is 2.2% of the surface area of the earth and 22 times of the 0.1% area. The number of population in the world is considered as about 6×10⁹ and accordingly, the above energy reflection rate can be realized if each of the mirrors is installed in the area of 75 m² (about 8.7 m×8.7 m) by each person. A further effect can be expected if the rate of area per mirror and the reflection rate of the mirror are increased.

Further, if the mirror surface is inclined so as to reflect the sun light normally with respect to the ground surface when the sun altitude at a region where the mirror 7 is installed becomes maximum, the path of the reflected light in the atmosphere of the earth can be shortened, the absorbing quantity of the reflected light in the atmosphere of the earth can be minimized, and the solar energy can be ejected to the outside of the earth more effectively. Further, in case that the mirror 7 is inclined as above, the path of the reflected light in the atmosphere can be more shortened than in a case that the inclined angle is 0°, even in the season that the sun altitude is not maximum, so that the absorbing quantity of the reflected light in the atmosphere can be reduced.

Further, as shown in FIG. 7, it is preferable to reflect the sunlight to a region high in latitude and low in temperature in the winter season. Further, the energy of the sunlight is transmitted to the region at a high speed as a radiation of light different from the transmission or circulation of heat, so that the elevation in temperature of the region where the mirror is installed can be suppressed and accordingly the consumption of energy for use in the heater at this region can be reduced, and that the global warming can be suppressed. Further, the distribution of the heat energy on the earth can be equalized, and accordingly the power such as the typhoon etc. generated by the temperature difference of the different latitude regions can be reduced.

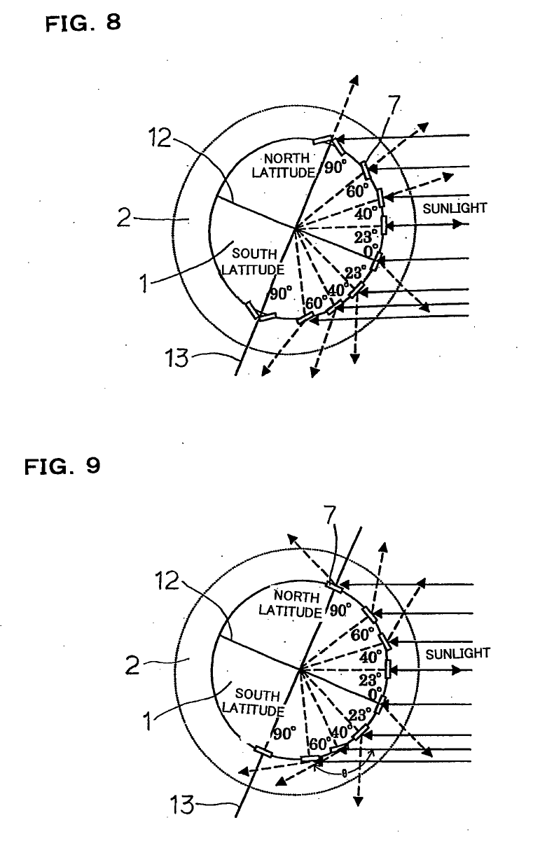

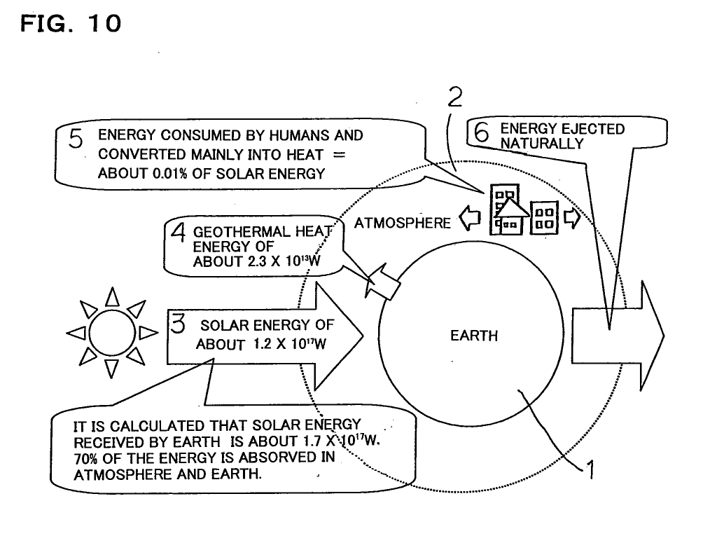

FIG. 8 shows incidence angles and reflection angles of the sunlight with respect to the mirrors installed on positions different in latitude from one another at 0 p.m. of the summer solstice of North hemisphere and the winter solstice of South hemisphere. In the season of high temperature at the North hemisphere, the path of the reflected light passing through the atmosphere is shortened, so that the absorbing quantity of the reflection light in the atmosphere can be minimized, and that the solar energy can be reflected to the outside of the earth more effectively. In the season of low temperature at the South hemisphere, the sunlight is reflected to a region high in latitude, so that the temperature at the region can be increased.

Further, it is preferable to install the mirrors on regions centering around a region low in latitude, and thus the incidence angle of sunlight is large, and high in temperature, so that the temperature of the rejoins where the mirrors are installed can be lowered, and to reduce the temperature difference between the near place of the equator and the near place of the north pole or the south pole, so that it is expected to reduce the power of the typhoon etc.

Further, it is preferable that the mirror installed in the region relatively high in latitude is covered with a cover of high extinction rate of the solar energy in the winter season in order to prevent the temperature from being lowered extremely.

Further, it is preferable to install the mirror at the housetop, roof, high ground or vast desert in order to prevent a bad influence due to the sunlight reflected from the mirror from being exerted on the car etc. running on the road.

If the mirror surface is not flat, but a concave or convex, the bundle of reflection lights forms a focal point and causes a fire etc. Accordingly, it is necessary to use a mirror having a sufficient flatness and solidity in order to prevent the mirror from being deflected by the weight of the mirror.

In case that a plurality of mirrors are used, if the mirrors are so arranged that reflection surfaces of the reflection plates form a concave surface, the bundle of the reflection lights forms a focal point and causes a fire etc. Accordingly, it is necessary to arrange the plural mirrors so as to form by the reflection surfaces thereof a convex surface or a planar surface. Further, it is accepted that any clearance or step is formed between the mirrors so far as the lights reflected from the reflection surfaces formed by the plural mirrors are not focused.

Further, if the inclined angle of each mirror is out of the predetermined value, a plurality of mirrors act as a concave mirror, the bundle of the reflected lights forms a focal point and causes a fire etc. and accordingly it is preferable to determine by a rule the inclined angle of the mirror.

Further, it is considered that the inclined angle of each mirror may be varied according to the season or time, however, it is difficult to vary at the same time all of the inclined angles of the mirrors. Accordingly, it is preferable to set the inclined angle of the mirror to a value and not varied the value, in order to prevent a focal point from being formed by a plurality of mirrors and caused a fire etc. and the cost becoming high.

Further, it is not necessary to set the inclined angle of the mirror so strictly that the sunlight is reflected perpendicular to the ground surface. It may be set that the inclined angles of the mirrors are the same with respect to regions of predetermined latitudes or country.

Further, it is preferable to use a reflection plate of high reflection rate with respect to ultra violet rays, visible rays and infrared rays in regions of wavelengths of 0.2-1.2 □m, 1.6-1.8 □m, 2-2.5 □m, 3.4-4.2 □m, 4.4-5.5 □m and 8-14 □m, which are so called as “atmospheric window” as like as the first embodiment.

It is preferable to use a reflection plate of high reflection rate with respect to infrared rays in regions of wavelengths of 0.83-1.2 □m etc. which occupies a relatively large portion of the solar energy reached to the ground surface, and to suppress the reflection of visible light in order to prevent a bad influence from being exerted on the airplane etc. flying in the air.

Further, the required inclined angle of the mirror 7 can be set to 0° instead of such an angle that the mirror reflects the sunlight perpendicular to the ground surface, when a sun altitude in a region where the reflection plate is installed becomes maximum and the mirror surface thereof is set in parallel to the ground surface.

In this case, the incidence angle and the reflection angle of the sunlight with respect to the ground surface are the same with each other. Accordingly, it is preferable to reflect the sunlight by a mirror installed in a region high in latitude and not faced to the sun to a region of higher in latitude and low in temperature. Further, the energy of the sunlight is transmitted into the region at a high speed as a radiation of light different from the transmission or circulation of heat, so that the elevation in temperature of the region higher in latitude and low in temperature can be suppressed and accordingly the consumption of energy for use in the heater at this region can be reduced, and that the global warming can be suppressed. Further, the distribution of the heat energy on the earth can be equalized, and accordingly the power such as the typhoon etc. generated by the temperature difference of the different latitude regions can be reduced.

Further, the required inclined angle of the mirror 7 can be set to such an angle that the sunlight is reflected by the mirror so as to pass through the atmosphere of a region higher in latitude and lower in temperature than that of a region where the mirror 7 is installed, instead of such an angle that the mirror reflects the sunlight perpendicular to the ground surface, when a sun altitude in the region where the mirror 7 is installed becomes maximum, as shown in FIG. 9. For example, in case that the temperature of a region higher in latitude than that of a region where the mirror 7 is installed is not high, a mirror installed at the region higher in latitude is inclined toward North pole of North hemisphere or South pole of South hemisphere. In this case, it is necessary to prevent the reflection light from being impinged on the ground surface, and to prevent any combinations of installed mirrors from forming a concave mirror. As shown in FIG. 9, the incidence angle of sunlight to the mirror becomes larger according to the increase in latitude of the region where the mirror is installed, at 0 p.m. of the winter solstice of North hemisphere or South hemisphere. Accordingly, in order to prevent the reflection light from being impinged on the ground surface, it is enough that an angle θ of the reflection light with respect to the incidence angle of the sunlight is set to an angle lower than (A+B)+90°, that is, an angle between the incidence angle of the sunlight and the normal line of the reflection surface is set to an angle lower than {(A+B)+90°}/2. In other words, the inclined angle of the mirror 7 toward North pole of North hemisphere or South pole of South hemisphere is set to an angle lower than {90°−(A+B)}/2. In case as shown in FIG. 9, mirrors installed in regions of north latitude 40° and south latitude 40° are inclined toward the North pole and South pole at 13° to the ground surface, respectively, and mirrors installed in regions of north latitude 60° and south latitude 60° are inclined at 3° to the ground surface similarly.

In this case, the sunlight is reflected by a mirror to a region high in latitude and low in temperature. Further, the energy of the sunlight is transmitted into the region at a high speed as a radiation of light different from the transmission or circulation of heat, so that the elevation in temperature of the region high in latitude and low in temperature can be suppressed and accordingly the consumption of energy for use in the heater at this region can be reduced, and that the global warming can be suppressed. Further, the distribution of the heat energy on the earth can be equalized, and accordingly the power such as the typhoon etc. generated by the temperature difference of the different latitude regions can be reduced.

Further, if the inclined angle of each mirror is out of the predetermined value, a plurality of mirrors act as a concave mirror, the bundle of the reflected lights forms a focal point and causes a fire etc. and accordingly it is preferable to determine by a rule the inclined angle of the mirror.

Further, it is considered that the inclined angle of each mirror may be varied according to the season or time, however, it is difficult to vary at the same time all of the inclined angles of the mirrors. Accordingly, it is preferable to set the inclined angle of the mirror to a value and not varied the value, in order to prevent a focal point from being formed by a plurality of mirrors and caused a fire etc. and the cost becoming high.

It may be set that the inclined angles of the mirrors are the same with respect to regions of predetermined latitudes or country.

Further, a plurality of systems with respect to the inclined angle of the mirror can be adopted at the same time, however, it is necessary to set such a rule that a concave mirror is not formed by any combination of the mirrors.

Further, it is considered that it is effective to determine by the law etc. the system of the installation of the mirrors in order to increase the reflection rate of the solar energy.

We claim:

1. A solar energy reflection plate for suppressing global warming, comprising: a reflection plate installed on a ground surface such that a reflection surface of the reflection plate is positioned horizontally to the ground surface.

2. A solar energy reflection plate for suppressing global warming, comprising:
a reflection plate, and
a base for fixing the reflection plate so as to tilt a reflection surface of the reflection plate at a desired angle in relative to a ground surface.

3. The solar energy reflection plate for suppressing global warming as claimed in claim 2, wherein the desired angle is one at which, when a sun altitude in a region where the reflection plate is installed becomes maximum, sunlight is reflected in a direction perpendicular to the ground surface of the region.

4. The solar energy reflection plate for suppressing global warming as claimed in claim 2, wherein the desired angle is 0°.

5. The solar energy reflection plate for suppressing global warming as claimed in claim 2, wherein the desired angle is an angle at which sunlight is reflected in a direction passing through an atmosphere on a region higher in latitude than a region where the reflection plate is installed.

6. The solar energy reflection plate for suppressing global warming as claimed in claim 3, wherein, when a sun altitude in a region where the reflection plate is installed becomes maximum, the desired angle for reflecting sunlight in a direction perpendicular to the ground surface of the region is characterized by (A−B)/2, where
A is a latitude of the region, and
B is a latitude of the regression line, in case that the region is higher in latitude than a north or south regression line.

7. The solar energy reflection plate for suppressing global warming as claimed in claim 3, wherein, when a sun altitude in a region where the reflection plate is installed becomes maximum, the desired angle for reflecting sunlight in a direction perpendicular to the ground surface of the region is 0°, in case that the region is lower in latitude than a north or south regression line.

8. The solar energy reflection plate for suppressing global warming as claimed in claim 1, wherein a plurality of reflection plates are arranged such that reflection surfaces of the reflection plates form one of a convex surface and a planar surface.

9. The solar energy reflection plate for suppressing global warming as claimed in claim 1, wherein the reflection plate is a plane mirror.

10. The solar energy reflection plate for suppressing global warming as claimed in claim 1, wherein the reflection plate has a high reflection rate with respect to ultra violet rays, visible rays, and infrared rays in regions of wavelengths of 0.2-1.2 μm, 1.6-1.8 μm, 2-2.5 μm, 3.4-4.2 μm, 4.4-5.5 μm, 8-14 μm, which are so called as “atmospheric window”.

11. The solar energy reflection plate for suppressing global warming as claimed in claim 2, wherein a plurality of reflection plates are arranged such that reflection surfaces of the reflection plates form one of a convex surface and a planar surface.

12. The solar energy reflection plate for suppressing global warming as claimed in claim 2, wherein the reflection plate is a plane mirror.

13. The solar energy reflection plate for suppressing global warming as claimed in claim 2 wherein the reflection plate has a high reflection rate with respect to ultra violet rays, visible rays, and infrared rays in regions of wavelengths of 0.2-1.2 μm, 1.6-1.8 μm, 2-2.5 μm, 3.4-4.2 μm, 4.4-5.5 μm, 8-14 μm.

14. The solar energy reflection plate for suppressing global warming as claimed in claim 3, wherein a plurality of reflection plates are arranged such that reflection surfaces of the reflection plates form one of a convex surface and a planar surface.

15. The solar energy reflection plate for suppressing global warming as claimed in claim 3, wherein the reflection plate is a plane mirror.

16. The solar energy reflection plate for suppressing global warming as claimed in claim 3 wherein the reflection plate has a high reflection rate with respect to ultra violet rays, visible rays, and infrared rays in regions of wavelengths of 0.2-1.2 μm, 1.6-1.8 μm, 2-2.5 μm, 3.4-4.2 μm, 4.4-5.5 μm, 8-14 μm.
